(19) United States
(12) Patent Application Publication
(10) Pub. No.: US 2013/0326339 A1
(43) Pub. Date: Dec. 5, 2013

(54) DOCUMENT CREATION SYSTEM, DOCUMENT CREATION DEVICE, AND COMPUTER READABLE MEDIUM

(71) Applicant: PFU LIMITED, Kahoku-shi (JP)

(72) Inventors: Shoichi HAGISAWA, Ishikawa (JP); Go DOJO, Ishikawa (JP); Hideo SANO, Ishikawa (JP)

(73) Assignee: PFU LIMITED, Kahoku-shi (JP)

(21) Appl. No.: 13/842,581

(22) Filed: Mar. 15, 2013

(30) Foreign Application Priority Data
May 31, 2012 (JP) 2012-124518

(51) Int. Cl. G06F 17/21

(52) U.S. Cl. CPC G06F 17/212
USPC 715/243

(57) ABSTRACT

There is provided a document creation system comprising a document creation device and a document browsing device, wherein the document creation device has a functional layer storage that stores functional layers which are to be superposed on an image, which are transparent at least partially, and whose functions are defined in predetermined regions of the layers, a selection section that selects the functional layer to be applied, from among the functional layers stored in the functional layer storage, and a synthesis section that superposes the functional layer selected by the selection section onto the image, and wherein the document browsing device performs display processing, input acceptance processing, or output processing on the image onto which the functional layer is superposed by the synthesis section in accordance with the superposed functional layer.

### CROSS-REFERENCE TO RELATED APPLICATIONS

This application is based on and claims priority under 35 USC 119 from Japanese Patent Application No. 2012-124518 filed May 31, 2012.

### FIELD

The present invention relates to a document creation system, a document creation device, and a computer readable medium.

### BACKGROUND

Japanese Patent Application Laid-Open (JP-A) No. 2003-6556 discloses a form processing device that is connected via the internet to a form data input device having a web browser. The form processing device includes a form definition information conversion unit which creates an HTML file used to transmit a form image to the form data input device so that the relevant form image may be displayed on it based on form definition information containing layout information, output control information, and input control information and a form output unit which provides an output, which is the relevant form, based on the form definition information and outputting data transmitted from the form data input device.

### SUMMARY

According to an aspect of the invention, there is provided a document creation system comprising a document creation device and a document browsing device, wherein the document creation device has a functional layer storage that stores functional layers which are to be superposed on an image, which are transparent at least partially, and whose functions are defined in predetermined regions of the layers, a selection section that selects the functional layer to be applied, from among the functional layers stored in the functional layer storage, and a synthesis section that superposes the functional layer selected by the selection section onto the image, and wherein the document browsing device performs display processing, input acceptance processing, or output processing on the image onto which the functional layer is superposed by the synthesis section in accordance with the superposed functional layer.

According to another aspect of the invention, there is provided a document creation device comprising: a functional layer storage that stores functional layers which are to be superposed on an image, which are transparent at least partially, and whose functions are defined in predetermined regions of the layers; a selection section that selects the functional layer to be applied, from among the functional layers stored in the functional layer storage; and a synthesis section that superposes the functional layer selected by the selection section onto the image.

According to another aspect of the invention, there is provided a non-transitory computer-readable medium storing thereon a computer program that causes a computer to perform a method comprising: storing functional layers which are to be superposed on an image, which are transparent at least partially, and whose functions are defined in predetermined regions of the layers; selecting the functional layer to be applied, from among the stored functional layers; and superposing the selected functional layer onto the image.

### BRIEF DESCRIPTION OF DRAWINGS

Exemplary embodiments of the present invention will be described in detail based on the following figures.

FIG. 1 is an explanatory view of an outline of a document creation system 1 according to an embodiment;

FIG. 2 is an explanatory diagram of a functional configuration of a document creation program 40 according to the embodiment;

FIG. 3 is an explanatory diagram of a functional configuration of a browsing terminal program 60 according to the embodiment;

FIG. 4 is an explanatory flowchart of operations (S50) of document creation processing;

FIG. 5 is an explanatory flowchart of operations (S90) of browsing terminal processing;

FIG. 6 is an explanatory view of function definition processing (S525) in FIG. 4;

FIG. 7 is a view illustrating synthesis processing (S535) in FIG. 4; and

FIG. 8 is a view illustrating display processing (S910) in FIG. 5.

### DESCRIPTION OF EMBODIMENT

The following will describe the configuration of an embodiment of the invention with reference to the drawings. However, the scope of the present invention is not limited to illustrated examples.

[System configuration]

A description will be given of an overall configuration of a document creation system 1.

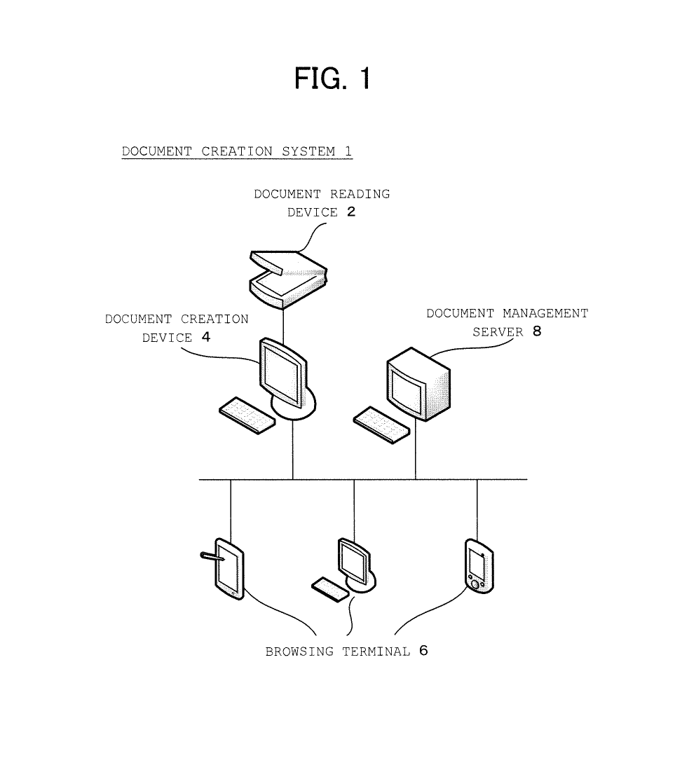

FIG. 1 is an explanatory view of an outline of the document creation system 1 according to the embodiment.

As illustrated in FIG. 1, the document creation system 1 according to the embodiment includes a document reading device 2, a document creation device 4, a browsing terminal 6, and a document management server 8.

The document reading device 2 has scanner functions to optically read an image from a manuscript placed on a manuscript table. The document reading device 2 outputs image data read from the manuscript to the document creation device 4.

The document creation device 4 is an example of the document creation device according to the invention.

The document creation device 4 is a computer terminal that manages a process of creating a document file by using image data and a functional layer whose function is defined in a predetermined region and has server functions. The document creation device 4 transmits the created document file to the browsing terminal 6. The document file as referred to here is an example of a data file in which the image data and the functional layer of the invention are consolidated.

In the present example, the document reading device 2 and the document creation device 4 are connected to each other with a communication line such as a USB cable, so that the document reading device 2 can send information to the document creation device 4. Further, the document reading device 2 and the document creation device 4 can be combined into one composite machine.

The browsing terminal 6 is an example of the document browsing device according to the invention.

The browsing terminal 6 is a computer terminal which is operated by a user. The browsing terminal 6 receives document files from the document creation device 4. The browsing terminal 6 performs functions in accordance with information defined in the functional layer, to accept information from the user. The browsing terminal 6 saves in a predetermined save destination a document file in which the information from the user is accepted.

The browsing terminal 6 may be, for example, a personal computer, scanner (network scanner), PDA, cellular phone, smart phone (multifunctional cellular phone), tablet information terminal, or a composite machine that has communication functions.

Further, in the present example, the document creation device 4 is connected to the browsing terminal 6 via the network and can exchange information even at various sites.

The document management server 8 is, for example, a computer terminal and has server functions. The document management server 8 saves document files whose entry is accepted. The browsing terminal 6 and the document management server 8 of the present example are connected to each other via the network and can exchange information even at various sites.

The document creation system 1 of the present example manages creation of a document file into which a functional layer and image data read from a manuscript are consolidated, in the system configuration described above. Further, it easily creates the document file quickly by using the set functional layer on a plurality of pieces of the image data.

Next, a description will be given of a document creation program 40.

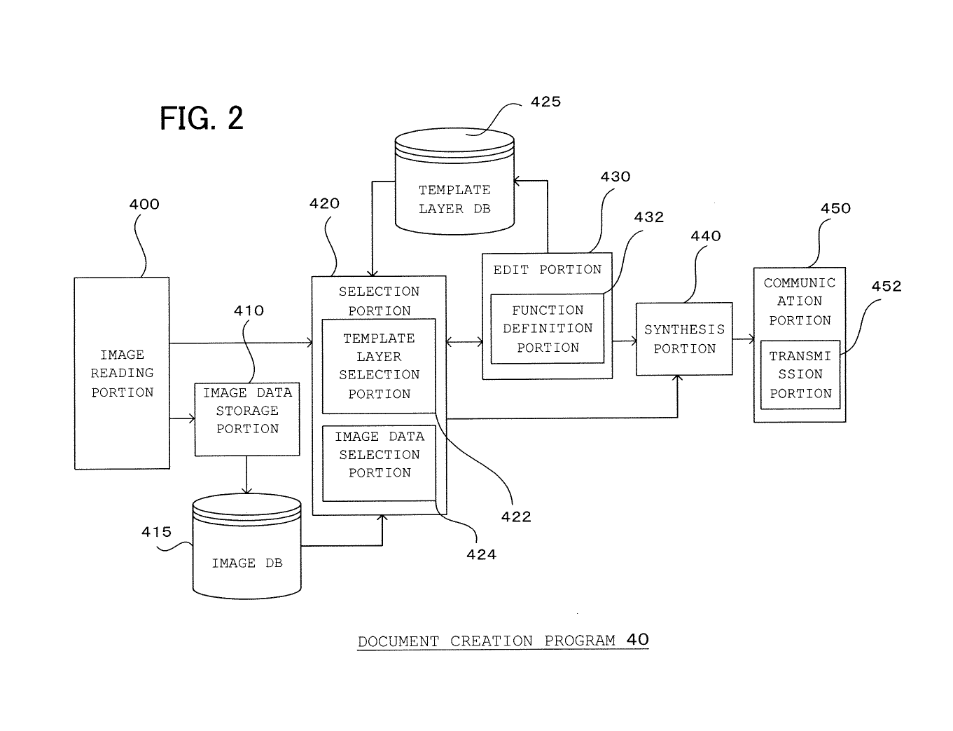

FIG. 2 is an explanatory diagram of a functional configuration of the document creation program 40 according to the embodiment.

The document creation program 40 is a computer program installed to the document creation device 4 via a recording medium such as a CD-ROM, for example.

As illustrated in FIG. 2, the document creation device 4 includes an image database 415 (image DB415) and a template database 425 (template DB425). Here, the template DB425 is an example of functional layer storage means according to the invention. The template DB425 stores functional layers which can be superposed on an image, which are transparent at least partially, and whose functions are defined in their predetermined regions. Further, the functional layer according to the invention refers to, for example, a template layer whose functions are defined in a predetermined region.

Further, as illustrated in FIG. 2, the document creation program 40 includes an image reading portion 400, an image data storage portion 410, a selection portion 420, an edit portion 430, a synthesis portion 440, and a communication portion 450. Further, the selection portion 420 includes a template layer selection portion 422 and an image data selection portion 424. Further, the edit portion 430 includes a function definition portion 432. Further, the communication portion 450 includes a transmission portion 452.

The image reading portion 400 receives from the document reading device 2 the data (image data) of an image generated by optically reading a manuscript.

Further, the image reading portion 400 may generate the image data by optically reading the image from the manuscript if, for example, the document reading device 2 and the document creation device 4 are combined.

The image data storage portion 410 stores the image data generated by the document reading device 2 in the image DB415.

The selection portion 420 selects the image data stored in the image DB415 and the data of the template layers stored in the template layer DB425. Specifically, the selection portion 420 includes the template layer selection portion 422 and the image data selection portion 424.

The image data selection portion 424 picks up image data selected by the user from the image data DB415.

Next, the template layer selection portion 422 selects a template to be applied from the template DB425. The selection portion 420 can select one or a plurality of template layers in which necessary information is attached to selected image data.

The selection portion 420 as referred to here is an example of the selection means according to the invention.

The edit portion 430 is an example of edit means according to the invention.

The edit portion 430 edits a template layer selected by the selection portion 420. Specifically, the edit portion 430 includes the function definition portion 432 that defines functions to at least a predetermined region of the template layer. More specifically, the function definition portion 432 adds definition information which causes at least an input acceptance function, a file control function, and a display control function to be performed. The function definition portion 432 adds the input acceptance definition function, the file control definition function, and the display control definition function to a predetermined region of the template layer, to perform the functions in accordance with the definition information added to the template layer if a document file into which the image data and the template layer are consolidated is opened by the browsing terminal 6.

The input acceptance function is configured to accept key input, handwritten input, selection operation, or image insertion and display results of the accepted input. Further, the input acceptance definition information that causes the input acceptance function to be performed contains a region in the template layer and the definition information which specifies a type of the input operation accepted in this region in response to a user instruction.

The file control function is configured to specify a transfer destination of the file as a whole, an output destination of the file, or addition of security to the file. Further, the file control definition information that causes the file control function to be performed contains the definition information which specifies the transfer destination of the file as a whole, the output destination of the file, or the addition of security to the file. Further, the file control definition information may contain the definition information which notifies that the file is opened.

The display control function is configured to specify a display range, a display size, or display order at least in a predetermined region of the template layer. Further, the display control definition information that causes the display control function to be performed contains the definition information which specifies a region in the template layer and the display range, the display size, or the display order in the region.

Further, the function definition portion 432 adds electronic authentication definition information that causes an electronic authentication generation function of generating electronic authentication information to be performed.

The electronic authentication function is configured to generate electronic authentication information to a specified superposition image or template layer in response to user specification. Further, the electronic authentication definition information that causes the electronic authentication function to be performed contains the definition information which commands generating electronic authentication information to the specified image or template layer. The electronic authentication information as referred to here is, for example, a time stamp or an electronic signature. Further, the function definition portion 432 can add a user name, position information, an output time, or a creation time.

The synthesis portion 440 superposes a data file of an image specified by the user and a template layer to be applied into one consolidated data file, to synthesize a document file. Specifically, the synthesis portion 440 consolidates image data and a template layer selected by the selection portion 420 or a template layer whose function is defined by the edit portion 430.

The communication portion 450 includes the transmission portion 452. The transmission portion 452 transmits the document file consolidated by the synthesis portion 440. Specifically, the transmission portion 452 transmits the document file to the browsing terminal 6.

Next, a description will be given of a browsing terminal program 60.

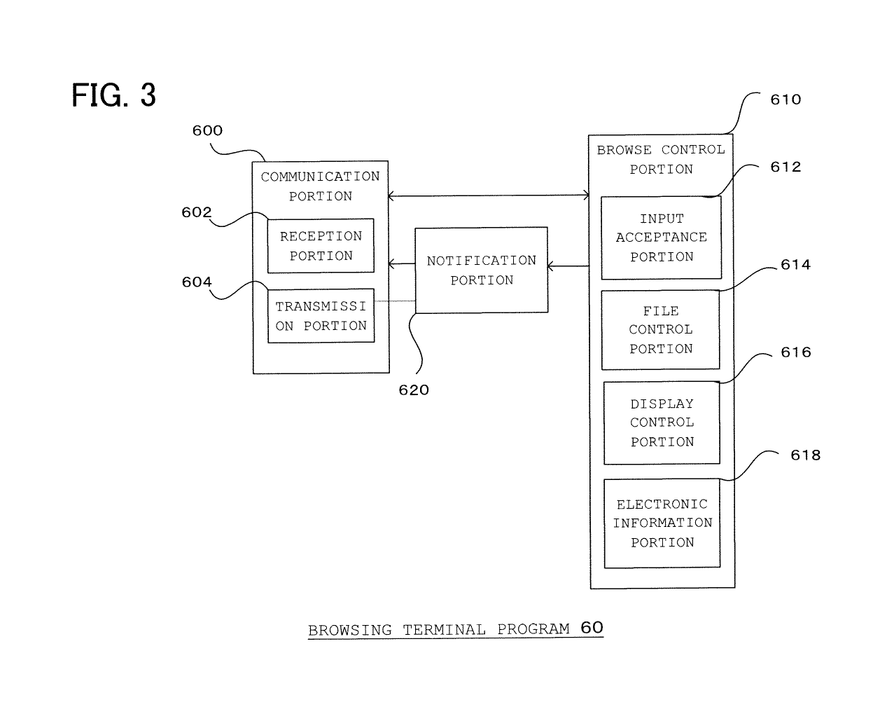

FIG. 3 is an explanatory diagram of a functional configuration of the browsing terminal program 60 according to the embodiment.

The browsing terminal program 60 is a computer program which is installed to the browsing terminal 6 via a recording medium such as a CD-ROM, for example. Further, the browsing terminal program 60 may be installed to the browsing terminal 6 as an application.

As illustrated in FIG. 3, the browsing terminal program 60 includes a communication portion 600, a browse control portion 610, and a notification portion 620.

The communication portion 600 includes at least a reception portion 602 and a transmission portion 604.

The reception portion 602 receives data transmitted from the document creation device 4. Specifically, the reception portion 602 receives a document file synthesized by the document creation program 40.

The transmission portion 604 transmits the document file received by the reception portion 602. Specifically, the transmission portion 604 transmits the document file processed by the later-described browse control portion 610 to a predetermined save destination.

The browse control portion 610 processes the document file received by the reception portion 602. Specifically, the browse control portion 610 performs the processing in accordance with definition information defined on a template layer data or image data contained in the document file by the document creation program 40.

The browse control portion 610 performs display processing, input acceptance processing, or output processing in accordance with the defined definition information and, therefore, includes at least an input acceptance portion 612, a file control portion 614, a display control portion 616, and an electronic information portion 618.

The display control portion 616 performs the display processing in accordance with the input acceptance definition information added to the template layer contained in the document file. Specifically, the display control portion 616 specifies the display range, the display size, or the display order at least in the predetermined region of the template layer.

The input acceptance portion 612 performs the input acceptance processing in accordance with the input acceptance definition information added to the template layer contained in the document file. Specifically, the input acceptance portion 612 accepts at least the key input, handwritten input, selection operation, or image insertion and displays the results of the accepted inputs.

The file control portion 614 performs the output processing in accordance with the file control definition information added to the template layer contained in the document file. Specifically, the file control portion 614 specifies the transfer destination of the file as a whole, output destination of the file, or addition of security to the file. The file control portion 614 performs processing to notify that the file is opened in accordance with the file control definition information.

The electronic information portion 618 performs processing to generate electronic authentication information in accordance with the electronic authentication definition information added to the template layer contained in the document file. Specifically, the electronic information portion 618 commands generating the electronic authentication information to the specified image or template layer.

The notification portion 620 notifies that the document file is opened based on the processing of the file control portion 614. The notification portion 620 selects communication means and prompts the transmission portion 604 to transmit the opened notification. The notification portion 620 may select, for example, a mail function to perform notification.

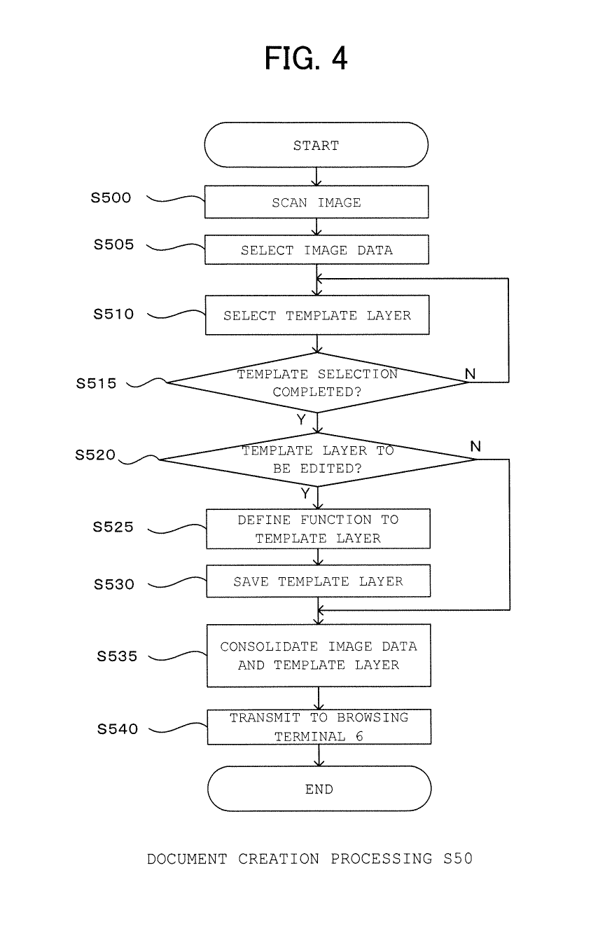

FIG. 4 is an explanatory flowchart of the operations (S50) of document creation processing.

As illustrated in FIG. 4, in step 500 (S500), the image reading portion 400 reads image data read out by the document reading device 2. The image data storage portion 410 stores the read image data in the image data DB415.

In step 505 (S505), the image data selection portion 424 selects image data specified by the user from the image DB415. The image data selection portion 424 may select the image data read out by the document reading device 2 in accordance with specification from the user.

In step 510 (S510), the template layer selection portion 422 selects a template layer to be applied, from among the template layers stored in the template layer DB425.

In step 515 (S515), the template layer selection portion 422 displays a decision as to whether necessary template layers are all selected.

The document creation processing S50 shifts to the processing in S510 if it has accepted a user's indication that it is necessary to select a template layer and to the processing in S520 if it has accepted a user's indication that selection of the template layer is completed.

In step 520 (S520), the selection portion 420 displays a decision as to whether the selected template layer is to be edited. If having accepted a user's indication that definition information is to be added to the template layer, the document creation processing S50 shifts to processing in S525. If having accepted a user's indication that no definition information is to be added to the template layer, the selection portion 420 shifts to processing in S535.

In step 525 (S525), the edit portion 430 defines a function in a predetermined region for the template layer selected by the template layer selection portion 422. Specifically, the function definition portion 432 adds at least the input acceptance definition information, the file control definition information, and the display control definition information that respectively cause the input acceptance function, the file control function, and the display control function to be performed to the predetermined region of the template layer. Further, the function definition portion 432 adds the electronic authentication definition information that causes the electronic authentication function of generating electronic authentication information to be performed.

In step 530 (S530), the edit portion 430 stores the template layer to which the definition information is added by the function definition portion 432, in the template layer DB425.

The selection portion 420 can select the template layer stored in the template layer DB425 by the edit portion 430 and use it, so that the template layer can be generated easily.

In step 535 (S535), the synthesis portion 440 superposes the user-specified image data and data of the template layer. Specifically, the template layer which is selected by the selection portion 420 or whose function is defined by the edit portion 430 is consolidated into the image to create a document file.

In step 540 (S540), the transmission portion 452 transmits the consolidated document file to the browsing terminal 6.

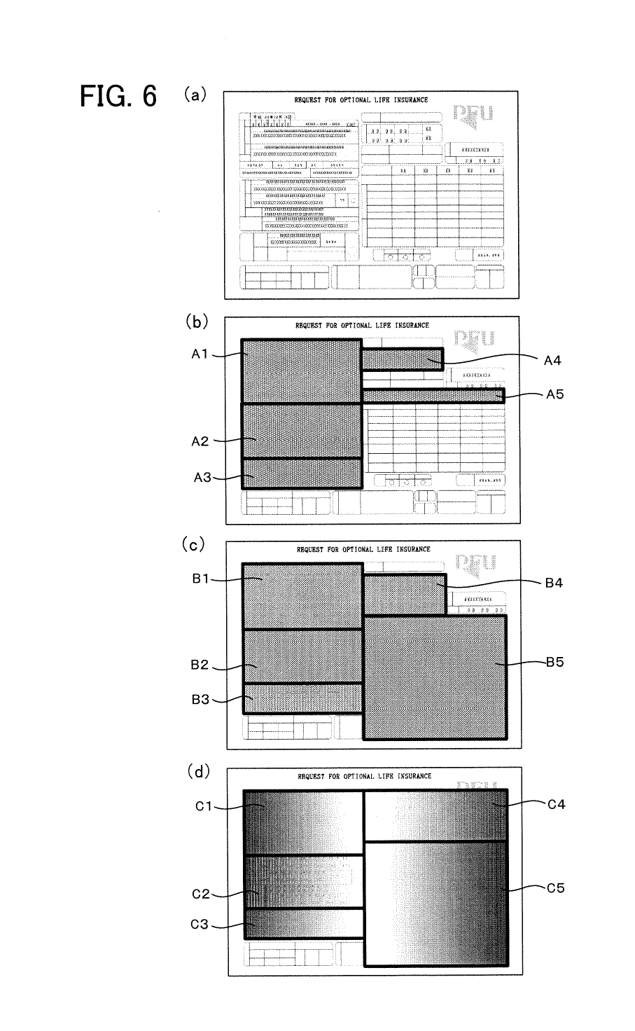

FIG. 6 is an explanatory view of the function definition processing (S525) in FIG. 4.

FIG. 6A illustrates an example of image data which is stored by the image data storage portion 410. The function definition portion 432 adds definition information to the template layer based on the image data stored by the image data storage portion 410.

Further, FIG. 6B illustrates the input acceptance definition information defined in regions A1 to A5 by the function definition portion 432 based on the image data. The function definition portion 432 adds the definition information so that at least the key input, handwritten input, selection operation, or image insertion may be accepted and the results of the accepted inputs may be displayed in the regions A1 to A5. The function definition portion 432 can arbitrarily change the region to which the definition is to be added.

Further, FIG. 6C illustrates the output definition information defined in regions B1 to B5 by the function definition portion 432 based on the image data. The function definition portion 432 adds definition information that specifies a transfer destination of the file as a whole, an output destination of the file, or addition of security to a file in the regions B1 to B5. The function definition portion 432 can add output definition information to, for example, a user-selected one of a plurality of the selected template layers. Further, the function definition portion 432 can specify a transfer destination of the file as a whole, an output destination of the file, or addition of security to the file by using the output definition information for each of the template layers. Further, besides security to the file, the function definition portion 432 can specify a region and add security to it.

FIG. 6D illustrates the display definition information defined in regions C1 to C5 by the function definition portion 432 based on the image data. In the regions C1 to C5, the function definition portion 432 adds the definition information that specifies a display range, a display size, or display order in at least a predetermined region in the template layer. The function definition portion 432 can change the region in which definition is to be added or also avoid defining.

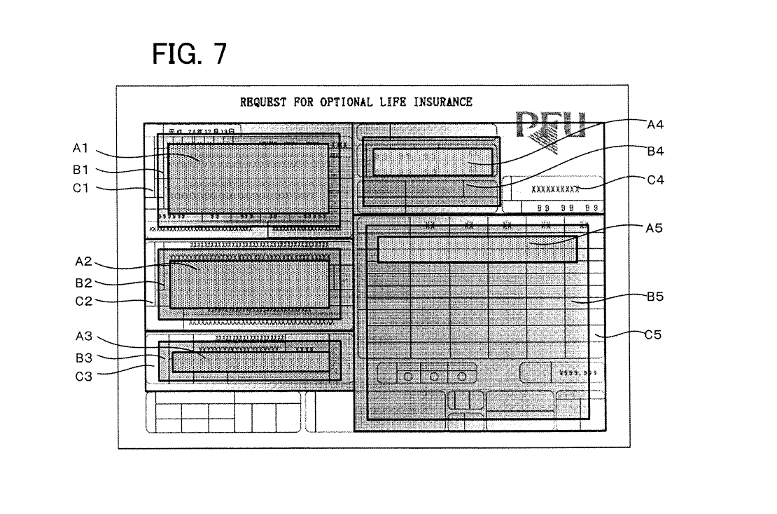

FIG. 7 is a view illustrating synthesis processing (S535) in FIG. 4.

As illustrated in FIG. 7, the synthesis portion 440 synthesizes a document file by superposing a template layer that the input acceptance definition information is defined in the regions A1 to A5 in FIG. 6B, a template layer that the output definition information is defined in the regions B1 to B5 in FIG. 6B, a template layer that the display definition information is defined in the regions C1 to C5 in FIG. 6B, and image data. The synthesis portion 440 can arbitrarily change order in which the definition information pieces are to be superposed. Further, the superposed definition information pieces illustrated in FIG. 7 are shown by changing their sizes partially so that they can be visualized.

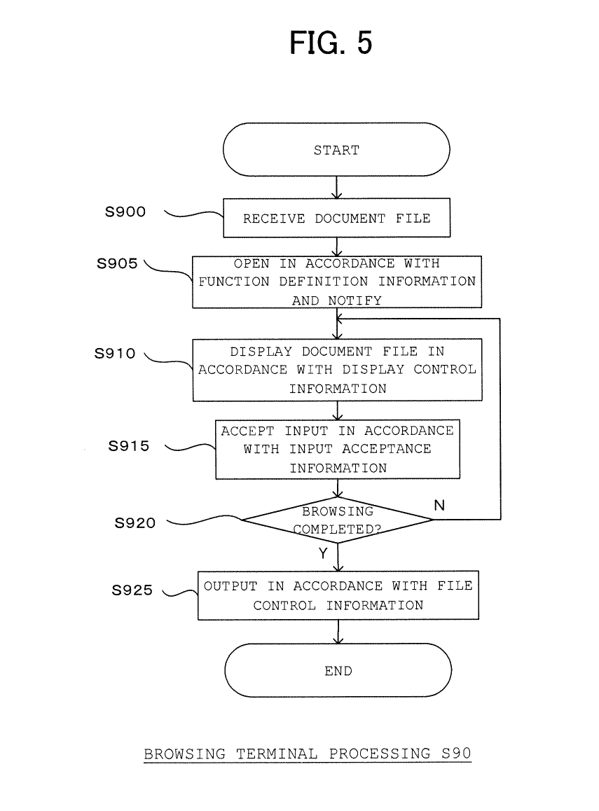

FIG. 5 is an explanatory flowchart of operations (S90) of browsing terminal processing.

As illustrated in FIG. 5, in step 900 (S900), the reception portion 602 receives a document file transmitted from the document creation device 4.

In step 905 (S905), the browse control portion 610 opens the received document file in accordance with the definition information defined in this document file. If the received document file is opened, the notification portion 620 selects notification means. The transmission portion 604 notifies a predetermined notification destination that the document file is opened, by using the notification means selected by the notification portion 620.

In step 910 (S910), the display control portion 616 displays the document file in accordance with the display definition information defined in a template layer contained in the document file.

In step 915 (S915), the input acceptance portion 612 accepts an input from the user in accordance with the input acceptance definition information defined in the template layer contained in the document file.

In step 920 (S920), the browse control portion 610 decides whether the information is input by the input acceptance portion 612 into a due region in the document file.

If the information is successfully input into the due region in the document file, the browsing terminal processing S90 shifts to processing in S925, and if the information is not successfully input into the due region in the document file, the browsing terminal processing S90 shifts to the processing in S910.

In step 925 (S925), the electronic information portion 618 performs processing to generate electronic authentication information in accordance with the electronic authentication definition information added to the template layer contained in the document file. Further, the file control portion 614 outputs the document file to the document management server 8 in accordance with the output definition information defined in the template layer contained in this document file.

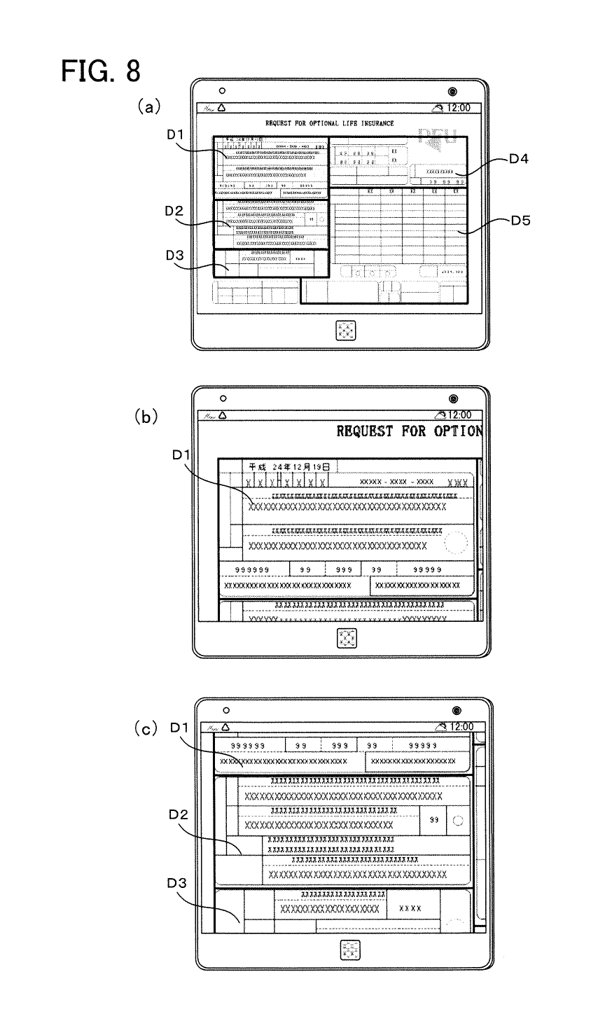

FIG. 8 is a view illustrating display processing (S910) in FIG. 5.

FIG. 8 illustrates an example of a pattern in which display is provided on the browsing terminal 6. The display control portion 616 displays the document file in accordance with the display definition information defined in the template layer contained in this document file.

In FIG. 8A, the document file is displayed on the browsing terminal 6. In FIG. 8B, a region of D1 of expanded by the display control portion 616 to show an accepted user input in accordance with the display definition information defined in the template layer. In FIG. 8C, the input in the region D1 is accepted by the display control portion 616 to then move a display region to the region D2 in accordance with the defined display definition information. In such a manner, the function definition portion 432 can provide display in accordance with the display control information. Further, the function definition portion 432 can automatically decide and display the display range, the display size, or the display order because it has defined them.

As described above, the document creation system 1 of the embodiment can easily create a consolidated document file by using image data optically read out by the document reading device 2 from a manuscript and a template layer defined in a predetermined region. Further, the document creation system 1 can supply a definition on a plurality of pieces of image data at a time and also add definition only to a specific piece of image data by using the template layers.

Further, as illustrated in FIGS. 8A to 8C, the document creation system 1 displays a pattern of display on the browsing terminal 6 in accordance with the display definition information and provides display by automatically deciding an expanded display range based on the layout (display contents) of the document file. Further, the document creation system 1 can specify an input method and security in each of the regions and output only part of the document file to a recording medium such as, for example, a sheet of paper in accordance with the input acceptance definition information and the output definition information. The document creation system 1 can add a time stamp and an electronic signature to a document file to be output and, further, add in detail the information of a user name, a time, and a position.

Further, the document creation system 1 creates documents based on image data read out from a manuscript and, therefore, can use a display method that utilizes visibility.

Although the embodiment according to the invention has been described, the invention is not limited to it and can be changed and supplemented variously as far as it does not depart from the gist of the invention.

### [Variants]

Next, a description will be given of a modification of the above embodiment.

Although the embodiment has been described with reference to the embodiment of superposing image data read by the document reading device 2 onto a template layer, the invention is not limited to it; for example, the image data selection means 424 may select an electronic document such as PDF data or image data saved in the document creation system 1 and superpose the template layer onto a display image of the selected data.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document creation system comprising a document creation device and a document browsing device,
wherein the document creation device has a functional layer storage that stores functional layers which are to be superposed on an image, which are transparent at least partially, and whose functions are defined in predetermined regions of the layers,
a selection section that selects the functional layer to be applied, from among the functional layers stored in the functional layer storage, and
a synthesis section that superposes the functional layer selected by the selection section onto the image, and
wherein the document browsing device performs display processing, input acceptance processing, or output processing on the image onto which the functional layer is superposed by the synthesis section in accordance with the superposed functional layer.

2. The document creation system according to claim 1,
wherein the document creation device further has an edit section that edits the functional layer selected by the selection section, and
wherein the synthesis section superposes the functional layer edited by the edit section onto the image.

3. The document creation system according to claim 1,
wherein the document creation device further has a function definition section that specifies the predetermined region to the functional layer selected by the selection section and defines at least an input acceptance function, a file control function, or a display control function, and
wherein the synthesis section superposes the functional layer whose function is defined by the function definition section onto the image.

4. The document creation system according to claim 3,
wherein the function definition section adds input acceptance definition information which specifies a region in the functional layer and a type of an input operation to be accepted in this region to this functional layer in response to an instruction from a user, and
wherein the document browsing device has an input acceptance section that accepts the input operation of the type specified by the input acceptance definition information in the region specified by the input acceptance definition information in the functional layer superposed onto the image to be displayed in accordance with the input acceptance definition information added to the functional layer and displays the accepted input operation in the region.

5. The document creation system according to claim 3,
wherein the function definition section adds at least output definition information which specifies a transfer destination of a file as a whole, an output destination of the file, or addition of security to the file, to the functional layer, and
wherein the document browsing device has an output control section that transfers the file containing the functional layer, outputs the file containing the functional layer, or adds security to the file containing the functional layer in accordance with the output definition information added to the functional layer.

6. The document creation system according to claim 3,
wherein the function definition section adds at least display definition information which specifies a display range, a display size, or display order to the functional layer in a predetermined region in the functional layer, and
wherein the document browsing device has a display control section that displays the image onto which the functional layer is superposed, in accordance with the display definition information added to the functional layer.

7. The document creation system according to claim 3,
wherein the function definition section adds, to the functional layer, electronic authentication definition information which specifies the image to be superposed onto the functional layer or the layer in accordance with specification of the user and commands generating electronic authentication information to the specified image or layer, and
wherein the document browsing device has an electronic authentication section that generates electronic authentication information to the image superposed onto the functional layer or the layer in accordance with the electronic authentication definition information added to the functional layer.

8. The document creation system according to claim 1, wherein:
the document creation device has a transmission section that transmits a consolidated data file, into the one consolidated data file, a data file of the image specified by the user and a data file of the selected functional layer being consolidated by the synthesis section; and
the document browsing device is a browsing device whose display screen has touch-sensitive panel functions and has a reception section that receives the one data file consolidated by the synthesis section and further receives the data file transmitted by the transmission section.

9. A document creation device comprising:
a functional layer storage that stores functional layers which are to be superposed on an image, which are transparent at least partially, and whose functions are defined in predetermined regions of the layers;
a selection section that selects the functional layer to be applied, from among the functional layers stored in the functional layer storage; and
a synthesis section that superposes the functional layer selected by the selection section onto the image.

10. A non-transitory computer-readable medium storing thereon a computer program that causes a computer to perform a method comprising:
storing functional layers which are to be superposed on an image, which are transparent at least partially, and whose functions are defined in predetermined regions of the layers;
selecting the functional layer to be applied, from among the stored functional layers; and
superposing the selected functional layer onto the image.
